(19) United States
(12) Patent Application Publication
(10) Pub. No.: US 2007/0188510 A1
(43) Pub. Date: Aug. 16, 2007

(54) Self-Adaptive Brush for Digital Images

(75) Inventor: Nils Kokemohr, Hamburg (DE)

Correspondence Address: NIK SOFTWARE, INC.;c/o SHELDON MAK ROSE & ANDERSON, 100 EAST CORSON STREET, THIRD FLOOR, PASADENA, CA, 91103-3842, US

(73) Assignee: NIK SOFTWARE, INC., San Diego, CA (US)

(21) Appl. No.: 11/674,080

(22) Filed: Feb. 12, 2007

Related U.S. Application Data
(60) Provisional application No. 60/772,053, filed on Feb. 10, 2006.

(51) Int. Cl. G09G 5/00

(52) U.S. Cl. 345/581

(57) ABSTRACT

A method for applying a selective enhancement to an image based on a pointing device input from a user, where responsive to a selection from the user image pixels are changed as a function of the pixel isolation from initial conditions. The initial conditions may be base conditions that are updated as the pointing device is moved. The change function may consider, inter alia, pixel characteristics measured at the initial coordinates of the pointing device click, the difference between the image pixel and the coordinates of the pointing device, the difference between the image pixel and the measured set of characteristics, the motion of the pointing device subsequent to the initial click, and the type of enhancement associated with this selective tool.

### CROSS-REFERENCE TO RELATED APPLICATION

The present Application claims the benefit of U.S. Provisional Patent Application No. 60/772,053 titled “Self-Adaptive Brush for Digital Images” filed Feb. 10, 2006, the content of which is incorporated by reference in this disclosure in its entirety.

### BACKGROUND OF THE INVENTION

This disclosure relates to digital image correction. This disclosure relates more particularly to a self-adaptive brush to modify a digital image when a user applies a brush stroke over the digital image to darken, lighten, sharpen or colorize the digital image.

### BACKGROUND

Currently a user who wants to manipulate a digital image must rely on time consuming and intricate software manipulations. Typically, if the user applies an editing function with a brush stroke, for example, to darken, lighten, or change the color of an object, or applies a filter, for example, to sharpen an object, the utmost care must be used so that the brush strokes match the object to be edited. It is the digital equivalent of “coloring within the lines.”Any mistakes or changes in the artistic process requires the time-consuming reworking of many regions of the digital image.

One approach currently used is to automatically change the pixels surrounding the area of the brush stroke applied by the user to the same color. Disadvantageously, this approach relies upon an automatically selected threshold that is or is not controllable by the user. Further disadvantageously, only a single characteristic, the pixel color, is used to compare the pixels surrounding the brush stroke with the brush stroke applied by the user. In another approach, the user draws a boundary around a region that is to be modified and then a filter or a mask is applied to the region inside of the boundary. Disadvantageously, when editing complex digital images, using this approach requires drawing a plurality of regions and applying the proper filter or applying a mask to each region. Further disadvantageously, the resulting edited digital image is not aesthetically pleasing if the user works too roughly or works too quickly. The current processes for modifying a digital image require excessive user interaction resulting in slow progress, multiple selection steps, careful tracing of regions, complex filtering treatments and complex mask manipulations. Therefore, there is a need for a software tool that provides a self-adaptive brush stroke for modifying digital images overcoming these limitations.

### SUMMARY

The present invention meets this need by providing a method for applying a selective enhancement to an image based on a pointing device input signal from a user, comprising the steps of displaying a preview to the user; allowing the user to use a pointing device on the preview and perform motions with the pointing device over the image; receiving a first input signal from the pointing device at initial coordinates within the image; recording the initial coordinates; measuring initial pixel characteristics at the initial coordinates; receiving a second input signal from the pointing device at second coordinates within the image; measuring second pixel characteristics at the second coordinates; determining a pixel isolation value from the initial pixel characteristics and second pixel characteristics; and changing the second pixel characteristics as a function of the determined pixel isolation value. The function may be continuous.

Changing the second pixel characteristics may also be a function of one or more of: the initial opacity settings, the default opacity settings, the motion of the pointing device subsequent to the first input signal, or the type of the enhancement.

In another embodiment, the method comprises the steps of displaying a preview to the user; allowing the user to use a pointing device on the preview and perform motions with the pointing device over the image; receiving a set of input signals from the pointing device defining a brush stroke within the image; measuring pixel characteristics for the brush stroke; measuring individual pixel characteristics for each pixel within the brush stroke; determining a pixel isolation value for each pixel within the brush stroke from the measured pixel characteristics and individual pixel characteristics; and changing the individual pixel characteristics as a function of the determined pixel isolation values.

Changing the individual pixel characteristics may also be a function of one or more of: the initial opacity settings, the default opacity settings, or the type of the enhancement.

A computer readable medium having contents for causing a computer-based information handling system to perform the steps of the methods is provided.

A kit comprising a pointing device and a computer readable medium having contents for causing a computer-based information handling system to perform the steps of the methods is disclosed.

The type of the enhancement may include a darken operation, a lighten operation, a color change operation, or a sharpen operation, among others.

In another embodiment, a method is disclosed to apply a selective enhancement to an image based on a pointing device input, comprising the steps of: receiving a first selection from a user, refining the selection opacity based upon, the original selective input from the user, the characteristics of the pixel or pixels at the center of the selection, the characteristics of the pixels in the original, unedited image, and a spatial distance to the center of the selection; storing the first modified selection opacity in a mask; receiving a second selection from a user; refining the second selection opacity based upon, the original selection, the characteristics of the pixel or pixels at the center of the second selection, the characteristics of the pixels in the original, unedited image, and a spatial distance to the center of the second selection; and overlaying the second modified selection opacity in a mask.

The mask, the original image and the desired enhancement may be combined and shown to the user as a preview. The overlaying of the second modified selection opacity and the mask may be performed using a multiply operation.

### BRIEF DESCRIPTION OF THE DRAWINGS

These and other features, aspects and advantages of the present invention will become better understood with regard to the following description, appended claims, and accompanying figures.

FIG. 1 is a flowchart showing the steps of a method for using a self-adaptive brush to modify a digital image according to the present invention.

FIG. 2 is a depiction of a self-adaptive brush stroke applied to a digital image in a digital image processing application, using an embodiment of the present invention.

FIG. 3 is a depiction of a digital image split into image blocks.

FIG. 4 is a scatter diagram of multivariate pixel characteristics of a digital image.

FIG. 5 is a depiction of a brush stroke with default opacity values, useable with the present invention.

FIG. 6 is a flowchart showing the steps of another embodiment of the present invention.

FIG. 7 is a series of depictions of an original image and masks generated according to the method of FIG. 6.

FIGS. 8A and 8B are opacity maps showing isolines of opacity changes.

### DETAILED DESCRIPTION

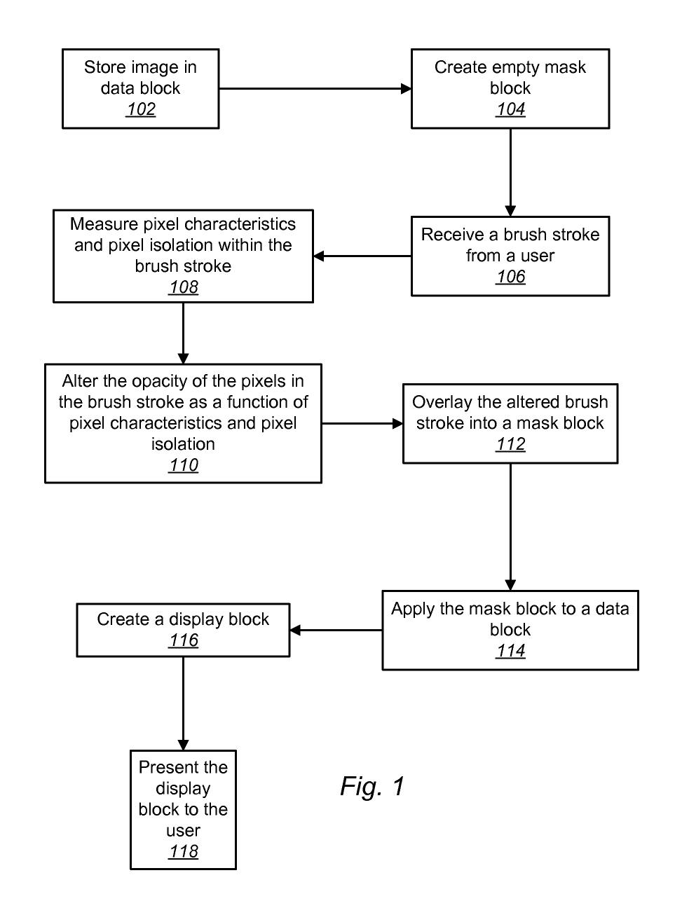

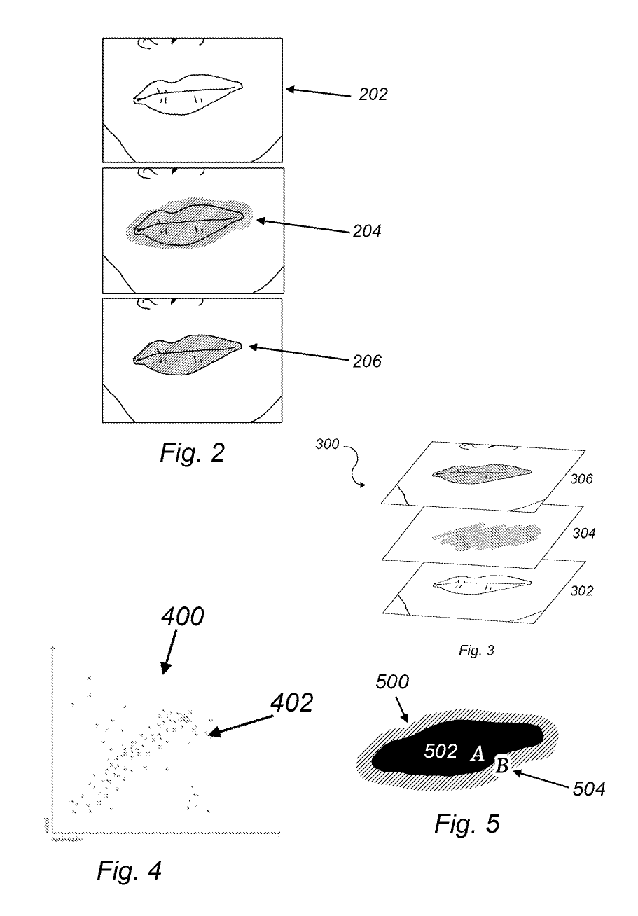

Referring to FIG. 1, there is shown a flowchart showing the steps of a method for using a self-adaptive brush to modify a digital image according to one embodiment of the present invention. First, a digital image is stored 102 in a data block. Then, an empty mask data block 104 is created. Next, a brush stroke is received 106 from a user. Then, a pixel characteristic, such as, for example, color, saturation, location, structure, or luminosity is measured 108 within the region of the brush stroke. “Pixel characteristics” is also described in U.S. Pat. No. 6,728,421 and U.S. Pat. No. 6,865,300 which are hereby incorporated by reference. It is assumed that this measurement is representative of what the user has intended to select. For example, with respect to the lips shown in FIG. 2, the measurement could yield a mean value that reflected the dominant current color of the lips. The isolation (e.g., “distance”) of pixels from that measured value is determined. Next, the opacity of the pixels within the brush stroke is changed 110 on the mask block as a function of those one or more measured pixel characteristics and pixel isolation. Then, the changed brush stroke is overlaid 112 onto the mask block. In the embodiment shown in FIG. 1, the mask block is applied 114 to the data block to create 116 a display block which is displayed 118 to the user. In another embodiment, the data block and the mask block are merged into the image block.

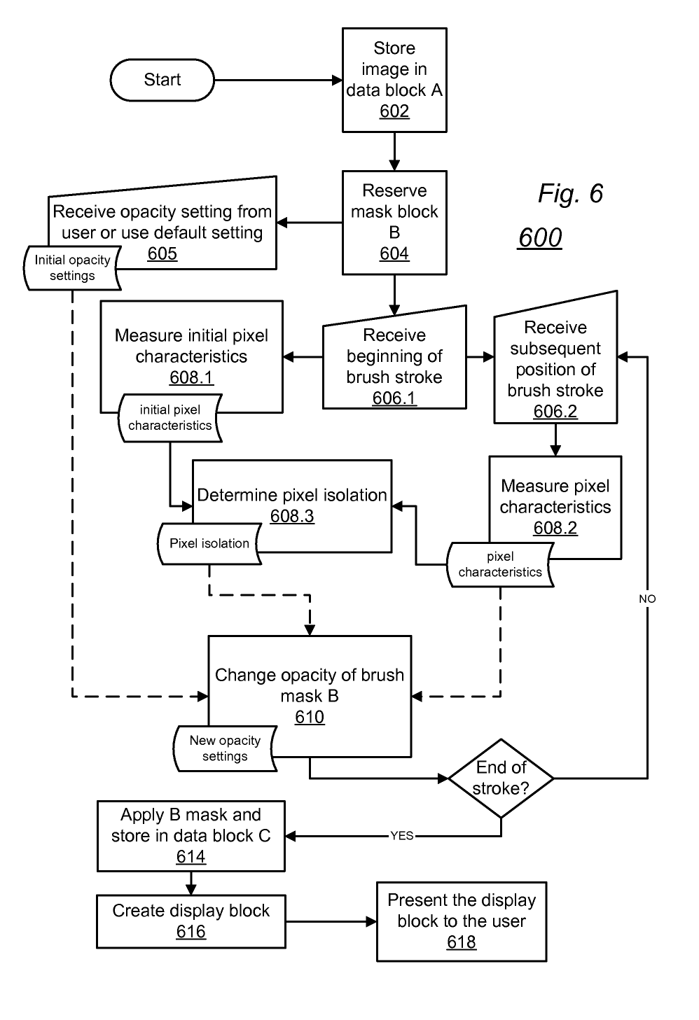

In one embodiment, the brush stroke in step 106 is completed before further processing takes place. This is useful with hardware that has limited computing power. Other embodiments, such as shown in FIG. 6, permit continuous adaptation as the brush stroke is being made. In fact, with sufficient hardware speed it would be possible to preview the result of the self-adapting brush as the brush stroke is being drawn.

In a further embodiment, the opacity change is also a function of the transparency of the original brush stroke (this might take place in a step such as step 605 of FIG. 6, for example). In another embodiment, the opacity change is also a function of the isolation of the pixel from a reference point (see as example step 608.1, FIG. 6, in which start of brush stroke is reference point).

In another embodiment, a “multiply” overlay mode (as will be understood by those with skill in the art, with reference to this disclosure) is used in step 112.

Referring now to FIG. 2, there is shown a depiction of a self-adaptive brush stroke applied to a digital image in a digital image processing application. An unaltered digital image 202 is presented to the user for modification. A self-adaptive brush stroke is applied to a region 204 to be modified. The method of the invention is used to calculate the change in the opacity of the pixels in the region 204 to be modified and creates a boundary for the region to limit the application of the self-adaptive brush stroke on the digital image. The image modified by the self-adaptive brush 206 is displayed. Optionally but preferably, this is without altering the original digital image 202.

Referring now to FIG. 3, there is shown a digital image 300 split into image blocks. The user applies a self-adaptive brush stroke to a region in a data block 302 of a digital image. The self-adaptive brush stroke is stored in a mask block 304. A region boundary is calculated and the opacity of the pixels to be changed is stored in the mask block 304. The mask block 304 and the data block 302 are combined using a “multiply” overlay mode and stored in the display block 306. The display block 306 is presented to the user with the changes from the self-adaptive brush stroke applied. In a different embodiment, the self-adaptive brush can alter an original digital image directly.

Determination of the isolation of a pixel can be accomplished in a variety of ways. Referring now to FIG. 4, there is shown a scatter diagram 400 of multivariate pixel characteristics 402 of a digital image, usable to darken, lighten, sharpen or colorize the digital image, according to the methods shown in FIGS. 1 and 6. Treating the points 402 as instances of a random variable X, the expected value E[X] of that random variable X yields a corresponding expectation for color and luminosity. The variance of the value of the random variable X at any given pixel from the expected value can be used as a metric for the isolation of that pixel.

In other embodiments, other multivariate statistical methods are employed to calculate the difference in pixel characteristics as will be understood by those with skill in the art, with reference to this disclosure. For example, a Mahalanobis distance could be used. Other pixel characteristics, such as, for example, saturation, transparency, and opacity can define an appropriate multivariate random variable as will be understood by those with skill in the art, with reference to this disclosure. Other methods of calculating a distance between pixels are disclosed in U.S. Pat. No. 6,728,421 and U.S. Pat. No. 6,865,300 which are incorporated by reference.

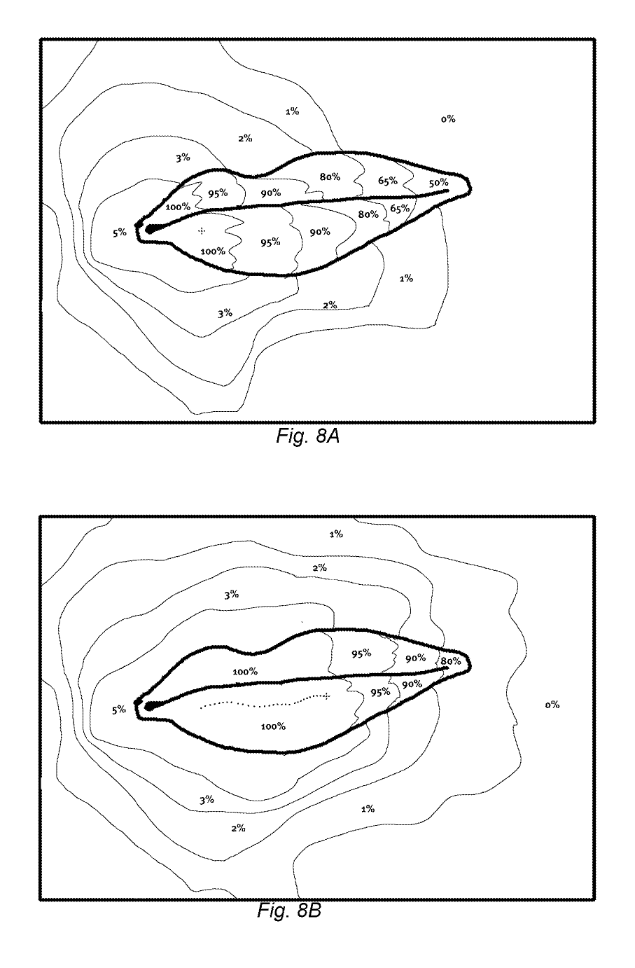

Determination of the boundary of the brush stroke can proceed in a variety of ways. In the simplest embodiment a threshold can be used to segment the region according to the opacity determined in steps 110 (FIG. 1) or 610 (FIG. 6). Preferably, a threshold is not used, and the output opacity of the self-adaptive brush stroke is a continuous function, such as is shown in the opacity maps of FIGS. 8A and 8B. The original opacity of the brush stroke and the variation of the characteristics of the current pixel from the characteristics of the surrounding pixels affected by the self-adaptive brush stroke could also be taken into account to form such a continuous function.

Default opacity settings can be used for initial opacity settings for the brush, which are further inputs to steps 110 and 610. Referring now to FIG. 5, in one embodiment the self-adaptive brush stroke 500 is comprised of an “A” full opacity region 502 and a “B” margin region 504 with lower opacity. This is useful for brush strokes that are used to outline features with natural boundaries, such as the lips of FIG. 2. The full opacity region 502 passes the full opacity change otherwise determined in steps 110 and 610 to a mask block, while the margin region further alters the change in opacity. As will now be evident to those of ordinary skill in the art, a wide range of default brush opacity settings are possible.

FIG. 6 shows a flowchart of another embodiment 600 of the invention. Image data is stored in data block A 602, and a preview is displayed to the user. A mask block B is then reserved 604. An opacity setting is received 605 from a user or from default settings such as described above, and initial opacity settings are determined. The user is allowed to point and click on the preview, using such pointing devices as a mouse, or pen tool. The initial coordinates of the beginning of a brush stoke are then received 606.1 and recorded when a pointing device click at a location within the image is made by the user. The initial pixel characteristics are measured 608.1 at that location. The initial position of a pointing device may be seen marked in FIG. 8A.

The user is allowed to perform motion with the pointing device over the image prior to the release of the pointing device click button. As the pointing device is moved, the subsequent position of the brush is received 606.2, and the new coordinates of the pointing device are recorded. The pixel characteristics are measured 608.2 at that new location. The pixel isolation is then determined 608.3 at those new coordinates.

The opacity of the brush is then changed 610 as a function of one or more of the pixel isolation value, the initial pixel characteristics, the pixel characteristics at the current coordinates, the initial opacity settings, or the default opacity settings. The pixel characteristics measured at the initial coordinates of the pointing device click, the difference between the initial coordinates and the current coordinates of the pointing device, and the difference between the current pixel characteristics and the initial pixel characteristics, could all be considered. In further embodiments, the motion of the pointing device subsequent to the initial click, and the type of enhancement associated with this selective tool are included in the function. Differences from mean values could also be included. In still further embodiments, the “initial pixel characteristics” could be updated during the brush stroke and the pixel isolation calculated on the basis of the updated initial pixel characteristics. In that embodiment the “initial pixel characteristics” are base pixel characteristics that when updated become inputs to the pixel isolation determination step 608.3.

In the embodiment shown in FIG. 6, if the stroke is not completed each subsequent position is received 606.2 and the change in opacity is repeated. A continuous map of opacity results as shown in FIG. 8B, where the mouse trail is shown for clarity. Once the stroke ends, as signaled for example by release of a button or further click, steps 614, 616 and 618 are processed resulting in display of the block to the user.

Although method 600 provides for adaptation as the stroke is being made, it waits for the completion of the brush stoke before displaying the results to the user. A further embodiment is possible, in which steps 614, 616 and 618 are processed during the stroke, thus giving the user a continuous view of the result of the brush stroke, as it is being applied.

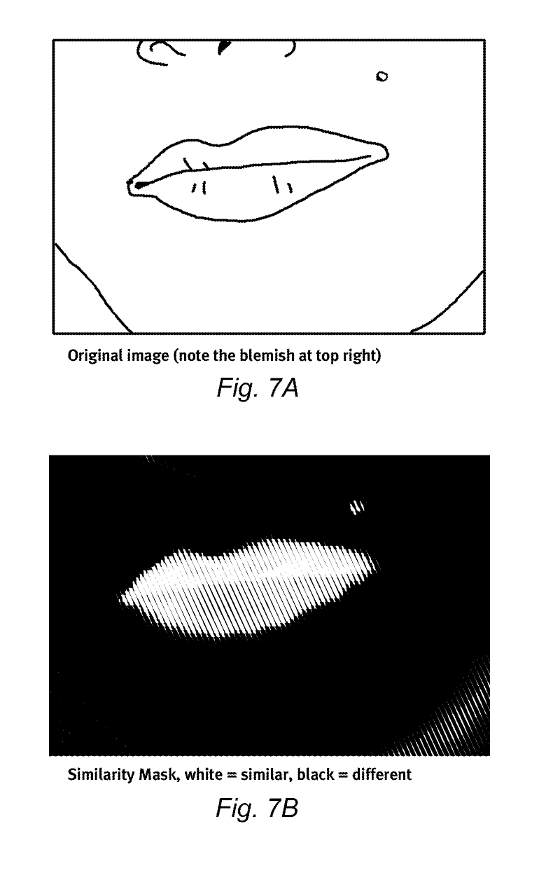

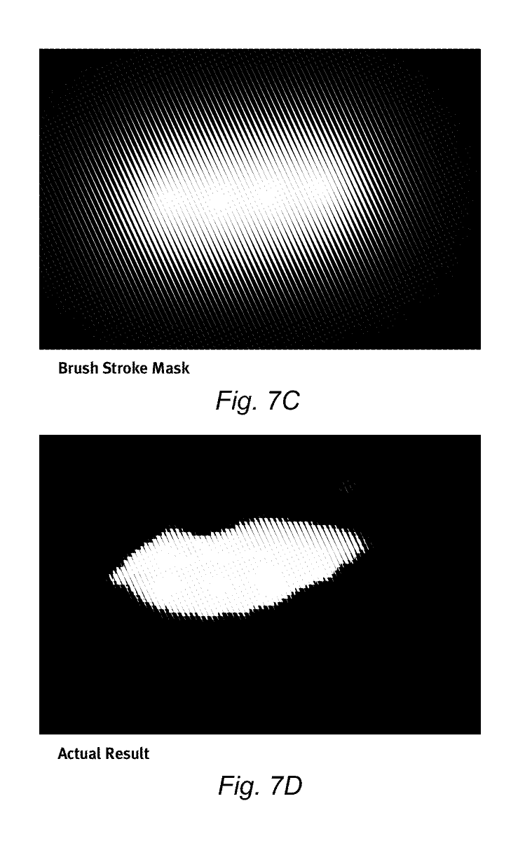

The process of using a continuous function in the embodiment of FIG. 6 is illustrated in FIGS. 7A through 7D. FIG. 7A depicts an original image with a blemish above the subject's lips, as stored 602 in a data block. FIG. 7B depicts a mask showing a variation of characteristics using the pixel isolation value determined in step 608.3. Bright areas indicate a strong similarity of a pixel to the set of measured characteristics (see above), dark pixels indicate a strong isolation. In more concrete terms, the brighter the pixel in FIG. 7B, the higher the similarity to the measured characteristics (e.g., the shade of red of the lips). Note that in FIG. 7B, not only the lips, but also the blemish and some other part of the skin show some non-zero values, although these are pixels the user does obviously not want to target. FIG. 7C depicts the original opacity brush mask of step 605, where the Initial Opacity Settings are determined, making use of brush stroke 500. White pixels indicate a high brush intensity value. FIG. 7D shows the result of said continuous function, that is, each pixel in FIG. 7D is the result of a continuous function applied to the corresponding pixel in FIG. 7B and the corresponding pixel in FIG. 7C, for instance a multiplication. In one embodiment the variation mask is normalized to a range of 0 . . . 1 and the brush mask to a range of 0 . . . 1 as well. For stronger intensity, a normalization of the brush mask to 0 . . . 1.5 or 0 . . . 2.0 may be desired. As it can be seen in FIG. 7D, most of the unwanted areas of FIG. 7B have now disappeared (see absence of blemish, nose, chin).

In another embodiment, the self-adaptive brush opacity of a brushed pixel is a continuous function of the initial self-adaptive brush opacity and the difference between the underlying pixel's characteristics and the self-adaptive brush mask opacity.

In another embodiment, an intermediate storage mask is employed so that succeeding self-adaptive brush strokes avoid the creation of artifacts of interaction between self-adaptive brush strokes. This allows multiple self-adaptive brush strokes to be applied to various regions of a digital image quickly. The interaction of each pixel of the self-adaptive brush stroke is not only compared to one reference color, but to a plurality of pixels within the brush stroke.

In another embodiment, each pixel of the self-adaptive brush stroke is compared to a plurality of pixels distributed over a certain length of the stroke.

A computer readable medium is provided having contents for causing a computer-based information handling system to perform the steps described herein.

Advantageously, the invention may be embodied on a computer readable medium having contents for causing a computer-based information handling system to perform the steps described herein, and packaged together with a pointing device, such as a mouse or pen tool, to be marketed as a kit.

This invention is not limited to particular hardware described herein, and any hardware presently existing or developed in the future that permits processing of digital images using the method disclosed can be used.

The term memory block or data block refers to any possible computer-related image storage structure known to those skilled in the art, including but not limited to RAM, processor cache, hard drive, or combinations of those, including dynamic memory structures. Preferably, the methods disclosed will be embodied in a computer program (not shown) either by coding in a high level language, or by preparing a plug-in application which is complied and available as an adjunct to an image processing program. The self-adaptive brush described herein is useable as a plug-in supplemental program, as an independent module that may be integrated into any commercially available image processing program, or into any image processing device that is capable of modifying and displaying an image, such as a color copier or a self service photo print kiosk, as a dynamic library file or similar module that may be implemented into other software programs whereby image measurement and modification may be useful, or as a stand alone software program.

Any currently existing or future developed computer readable medium suitable for storing data can be used to store the programs embodying the afore-described interface, methods and algorithms, including, but not limited to hard drives, floppy disks, digital tape, flash cards, compact discs, and DVDs. The computer readable medium can comprise more than one device, such as two linked hard drives. This invention is not limited to the particular hardware used herein, and any hardware presently existing or developed in the future that permits image processing can be used.

The drawings and the associated descriptions are provided to illustrate embodiments of the invention and not to limit the scope of the invention. Reference in the specification to “one embodiment” or “an embodiment” is intended to indicate that a particular feature, structure, or characteristic described in connection with the embodiment is included in at least an embodiment of the invention. The appearances of the phrase “in one embodiment” or “an embodiment” in various places in the specification are not necessarily all referring to the same embodiment.

As used in this disclosure, except where the context requires otherwise, the term “comprise” and variations of the term, such as “comprising”, “comprises” and “comprised” are not intended to exclude other additives, components, integers or steps.

Also, it is noted that the embodiments are disclosed as a process that is depicted as a flowchart, a flow diagram, a structure diagram, or a block diagram. Although a flowchart may disclose various steps of the operations as a sequential process, many of the operations can be performed in parallel or concurrently. The steps shown are not intended to be limiting nor are they intended to indicate that each step depicted is essential to the method, but instead are exemplary steps only.

The term “storage medium” can represent one or more devices for storing data, including read-only memory (ROM), random access memory (RAM), magnetic disk storage mediums, optical storage mediums, flash memory devices, electrical storage mediums or other mediums for storing information in a form readable by a machine such as, for example, a computer. The term “data element” refers to any quantum of data packaged as a single item. The term “data unit” refers to a collection of data elements or data units that comprise a logical section. The term “image block” refers to a complete copy or partial copy of a digital image that is stored in a separate storage location and can be altered without affecting the original stored digital image.

Although the present invention has been discussed in considerable detail with reference to certain preferred embodiments, other embodiments are possible. Therefore, the scope of the appended claims should not be limited to the description of preferred embodiments contained in this disclosure. All features disclosed in the specification, including the claims, abstract, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent or similar purpose, unless expressly stated otherwise. Thus, unless expressly stated otherwise, each feature disclosed is one example only of a generic series of equivalent or similar features.

I claim:

1. A method for applying a selective enhancement to an image based on a pointing device input signal from a user, comprising the steps of:
displaying a preview to the user;
allowing the user to use a pointing device on the preview and perform motions with the pointing device over the image;
receiving a first input signal from the pointing device at initial coordinates within the image;
recording the initial coordinates;
measuring initial pixel characteristics at the initial coordinates;
receiving a second input signal from the pointing device at second coordinates within the image;
measuring second pixel characteristics at the second coordinates;
determining a pixel isolation value from the initial pixel characteristics and second pixel characteristics; and
changing the second pixel characteristics as a function of the determined pixel isolation value.

2. A method for applying a selective enhancement to an image based on a pointing device input signal from a user, comprising the steps of:
displaying a preview to the user;
allowing the user to use a pointing device on the preview and perform motions with the pointing device over the image;
receiving a set of input signals from the pointing device defining a brush stroke within the image;
measuring pixel characteristics for the brush stroke;
measuring individual pixel characteristics for each pixel within the brush stroke;
determining a pixel isolation value for each pixel within the brush stroke from the measured pixel characteristics and individual pixel characteristics; and
changing the individual pixel characteristics as a function of the determined pixel isolation values.

3. A computer readable medium having contents for causing a computer-based information handling system to perform the steps of the method of claim 1.

4. A computer readable medium having contents for causing a computer-based information handling system to perform the steps of the method of claim 2.

5. A kit comprising a pointing device and a computer readable medium having contents for causing a computer-based information handling system to perform the steps of the method of claim 1.

6. A kit comprising a pointing device and a computer readable medium having contents for causing a computer-based information handling system to perform the steps of the method of claim 2.

7. The method of claim 1, where changing the second pixel characteristics is also a function of one or more of: the initial opacity settings, the default opacity settings, the motion of the pointing device subsequent to the first input signal, or the type of the enhancement.

8. The method of claim 7, where the type of the enhancement is a darken operation, a lighten operation, a color change operation, or a sharpen operation.

9. The method of claim 2, where changing the individual pixel characteristics is also a function of one or more of: the initial opacity settings, the default opacity settings, or the type of the enhancement.

10. The method of claim 9, where the type of the enhancement is a darken operation, a lighten operation, a color change operation, or a sharpen operation.

11. The method of claim 1, where the pixel change function is a continuous function.

12. The method of claim 1, where the pixel characteristics include pixel location and color.

13. The method of claim 1, where the initial pixel characteristics are base pixel characteristics that are updated prior to receiving the second input signal.

14. A method to apply a selective enhancement to an image based on a pointing device input, comprising the steps of:
receiving a first selection from a user,
refining the selection opacity based upon,
the original selective input from the user,
the characteristics of the pixel or pixels at the center of the selection,
the characteristics of the pixels in the original, unedited image, and
a spatial distance to the center of the selection;
storing the first modified selection opacity in a mask;
receiving a second selection from a user;
refining the second selection opacity based upon,
the original selection,
the characteristics of the pixel or pixels at the center of the second selection,
the characteristics of the pixels in the original, unedited image, and
a spatial distance to the center of the second selection; and
overlaying the second modified selection opacity in a mask.

15. The method of claim 14, where the mask, the original image and the desired enhancement are combined and shown to the user as a preview.

16. The method of claim 14, where the overlaying of the second modified selection opacity and the mask is performed using a multiply operation.
